(19) United States
(12) Patent Application Publication
(10) Pub. No.: US 2011/0286846 A1
(43) Pub. Date: Nov. 24, 2011

(54) SUN-AND-PLANET SPEED-UP GEAR

(75) Inventors: Katsuhiko Shoda, Nagasaki (JP); Kenji Sakai, Shiga (JP); Kazutaka Suzuki, Shiga (JP)

(73) Assignee: MITSUBISHI HEAVY INDUSTRIES, LTD., Tokyo (JP)

(21) Appl. No.: 12/678,821

(22) PCT Filed: Jan. 29, 2010
(86) PCT No.: PCT/JP2010/051220

§ 371 Date: Apr. 14, 2010

(30) Foreign Application Priority Data
Feb. 16, 2009 (JP) 2009-032616

(51) Int. Cl. F03D 11/02; F16H 57/08

(52) U.S. Cl. 416/170 R; 475/335

(57) ABSTRACT

A sun-and-planet speed-up gear includes a low-speed-stage sun-and-planet gearing and a high-speed-stage sun-and-planet gearing, in which an input shaft is connected to a low-speed-stage ring gear, the position of a shaft of a low-speed-stage planet gear is secured, a shaft of a low-speed-stage sun gear is connected to a high-speed-stage carrier, and an output shaft is connected to a high-speed-stage sun gear. In order to automatically center the low-speed-stage sun gear to prevent damage to gears and a bearing, a flange formed at a tip of the shaft of the low-speed-stage sun gear and a flange formed at a tip of a coupling that is directly attached to the high-speed-stage carrier or that is formed on the high-speed-stage carrier are coupled via a sleeve.

### RELATED APPLICATIONS

The present application is based on International Application Number PCT/JP2010/051220, filed Jan. 29, 2010, and claims priority from Japanese Application Number 2009-032616, filed Feb. 16, 2009, the disclosures of which are hereby incorporated by reference herein in their entirety.

### TECHNICAL FIELD

The present invention relates to sun-and-planet speed-up gears suitably used for wind turbines etc.

### BACKGROUND ART

An example known sun-and-planet gearing (hereinafter, referred to as “sun-and-planet speed-up gear”) used for a wind turbine is disclosed in Patent Literature 1.

### CITATION LIST

### Patent Literature

### {PTL 1}

Japanese Unexamined Patent Application, Publication No. 2005-233277

### SUMMARY OF INVENTION

### Technical Problem

However, in such a conventional sun-and-planet speed-up gear, a flange formed at the tip of the shaft of a low-speed-stage (first-stage) sun gear is directly secured (directly attached) to a high-speed-stage carrier via a plurality of bolts and nuts. Therefore, the centering properties of the low-speed-stage sun gear is poor (the distances between the center of the low-speed-stage sun gear and the centers of low-speed-stage planet gears revolving about the low-speed-stage sun gear are different for each of the low-speed-stage planet gears), the degree of contact with the low-speed-stage sun gear and the load received from the low-speed-stage sun gear are different for each of the low-speed-stage planet gears, and thus tooth surfaces of the low-speed-stage sun gear and the low-speed-stage planet gears may be damaged and a bearing that rotatably supports an input shaft may be damaged.

The present invention has been made in view of the above-described circumstances, and an object thereof is to provide a sun-and-planet speed-up gear capable of automatically centering the low-speed-stage sun gear and of preventing damage to the gears and the bearing.

### Solution to Problem

In order to solve the above-described object, the present invention employs the following solutions.

According to a first aspect, the present invention provides a sun-and-planet speed-up gear including: a low-speed-stage sun-and-planet gearing; and a high-speed-stage sun-and-planet gearing, an input shaft being connected to a low-speed-stage ring gear, the position of a shaft of a low-speed-stage planet gear being secured, a shaft of a low-speed-stage sun gear being connected to a high-speed-stage carrier, and an output shaft being connected to the high-speed-stage sun gear, in which a flange formed at a tip of the shaft of the low-speed-stage sun gear and a flange formed at a tip of a coupling that is directly attached to the high-speed-stage carrier or that is formed on the high-speed-stage carrier are coupled via a sleeve.

According to the sun-and-planet speed-up gear of the first aspect of the present invention, the flange formed at the tip of the shaft of the low-speed-stage sun gear and the flange formed at the tip of the coupling that is directly attached to the high-speed-stage carrier or that is formed on the high-speed-stage carrier are coupled via the sleeve, so that the low-speed-stage sun gear can move (somewhat: slightly) in parallel in the radial direction.

Therefore, when the low-speed-stage sun gear is assembled, the low-speed-stage sun gear is automatically centered (the low-speed-stage sun gear automatically moves to a position where the distances between the center of the low-speed-stage sun gear and the centers of the low-speed-stage planet gears are equal), and thus damage to tooth surfaces of the low-speed-stage sun gear and the low-speed-stage planet gears and to a bearing that rotatably supports the input shaft can be prevented.

According to a second aspect, the present invention provides a sun-and-planet speed-up gear including: a low-speed-stage sun-and-planet gearing; and a high-speed-stage sun-and-planet gearing, an input shaft being connected to a low-speed-stage ring gear, the position of a shaft of a low-speed-stage planet gear being secured, a shaft of a low-speed-stage sun gear being connected to a high-speed-stage carrier, and an output shaft being connected to the high-speed-stage sun gear, in which coupling is made via a flexible coupling one end of which is attached to a flange formed at a tip of the shaft of the low-speed-stage sun gear and the other end of which is attached to the high-speed-stage carrier.

According to the sun-and-planet speed-up gear of the second aspect of the present invention, the low-speed-stage sun gear and the high-speed-stage carrier are coupled via the flexible coupling one end of which is directly attached to the flange formed at the tip of the shaft of the low-speed-stage sun gear and the other end of which is attached to the high-speed-stage carrier, so that the low-speed-stage sun gear can move (somewhat: slightly) in parallel in the radial direction.

Therefore, when the low-speed-stage sun gear is assembled, the low-speed-stage sun gear is automatically centered (the low-speed-stage sun gear automatically moves to a position where the distances between the center of the low-speed-stage sun gear and the centers of the low-speed-stage planet gears are equal), and thus damage to the tooth surfaces of the low-speed-stage sun gear and the low-speed-stage planet gears and to the bearing that rotatably supports the input shaft can be prevented.

A wind turbine according to a third aspect of the present invention includes a sun-and-planet speed-up gear in which, when the low-speed-stage sun gear is assembled, the low-speed-stage sun gear is automatically centered (the low-speed-stage sun gear automatically moves to a position where the distances between the center of the low-speed-stage sun gear and the centers of the low-speed-stage planet gears are equal), and thus damage to the tooth surfaces of the low-speed-stage sun gear and the low-speed-stage planet gears and to the bearing that rotatably supports the input shaft can be prevented.

According to the wind turbine of the third aspect of the present invention, damage to the tooth surfaces of the low-speed-stage sun gear and the low-speed-stage planet gears and to the bearing that rotatably supports the input shaft can be prevented, thereby improving reliability and durability.

### Advantageous Effects of Invention

According to the present invention, an advantage is afforded in that the low-speed-stage sun gear is automatically centered, and damage to the gears and the bearing can be prevented.

### BRIEF DESCRIPTION OF DRAWINGS

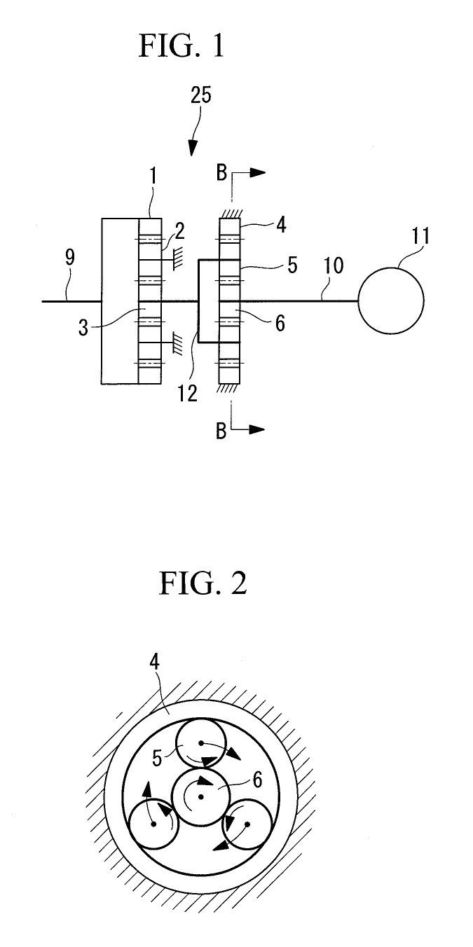

### {FIG. 1}

FIG. 1 is a longitudinal sectional view of a sun-and-planet speed-up gear according to a first embodiment of the present invention.

### {FIG. 2}

FIG. 2 is a sectional view along the arrows B-B shown in FIG. 1.

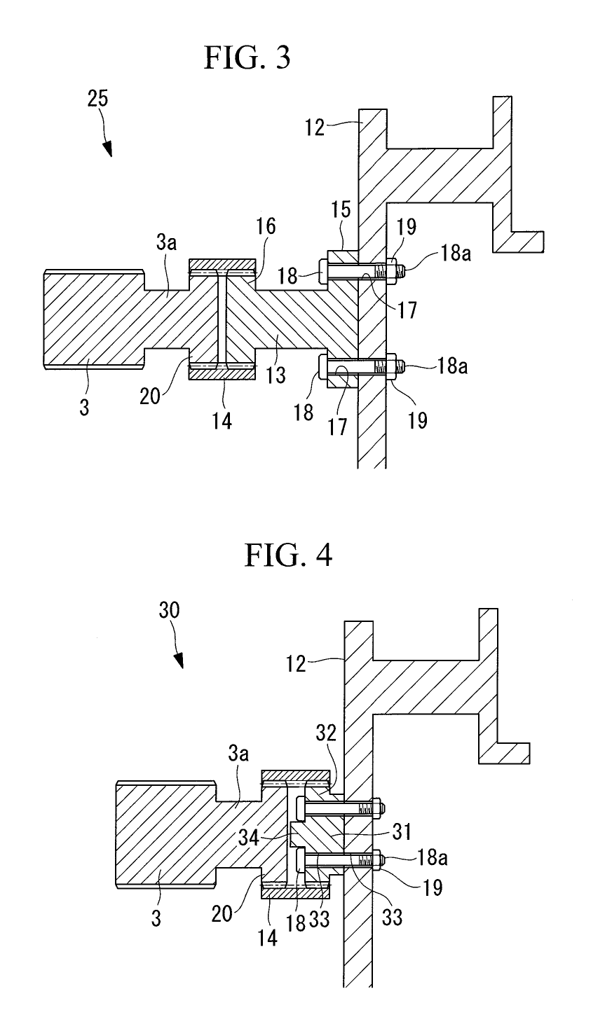

### {FIG. 3}

FIG. 3 is an enlarged main-portion view showing an enlarged main portion shown in FIG. 1.

### {FIG. 4}

FIG. 4 is a sectional view of a sun-and-planet speed-up gear according to a second embodiment of the present invention and is an enlarged main-portion view showing an enlarged main portion thereof.

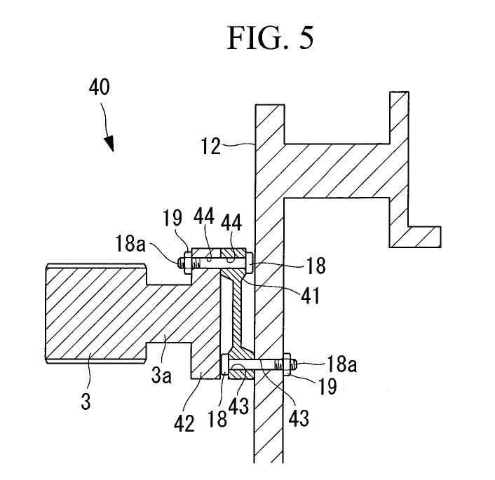

### {FIG. 5}

FIG. 5 is a sectional view of a sun-and-planet speed-up gear according to a third embodiment of the present invention and is an enlarged main-portion view showing an enlarged main portion thereof.

### DESCRIPTION OF EMBODIMENTS

A sun-and-planet speed-up gear according to a first embodiment of the present invention will be described below with reference to FIG. 1 to FIG. 3.

FIG. 1 is a longitudinal sectional view of the sun-and-planet speed-up gear according to this embodiment. FIG. 2 is a sectional view along the arrows B-B shown in FIG. 1. FIG. 3 is an enlarged main-portion view showing an enlarged main portion shown in FIG. 1.

A sun-and-planet speed-up gear 25 according to this embodiment is used for a wind turbine (not shown), for example. In FIG. 1, reference numeral 9 denotes an input shaft, reference numeral 10 denotes an output shaft, and reference numeral 11 denotes a power generator connected to the output shaft 10. A low-speed-stage (first-stage) sun-and-planet gearing (star-type sun-and-planet gearing) is provided close to the input shaft 9, and a high-speed-stage (second-stage) sun-and-planet gearing (planetary-type sun-and-planet gearing) is provided close to the output shaft 10. Reference numeral 1 denotes a low-speed-stage ring gear that is connected to the input shaft 9 to rotate therewith, reference numeral 2 denotes low-speed-stage planet gears that are engaged with the low-speed-stage ring gear 1 and that rotate about their fixed axes, and reference numeral 3 denotes a low-speed-stage sun gear that is engaged with the low-speed-stage planet gears 2 to rotate therewith.

In FIG. 1 and FIG. 2, reference numeral 4 denotes a fixed high-speed-stage ring gear, reference numeral 5 denotes high-speed-stage planet gears that are engaged with the high-speed-stage ring gear 4 to rotate therewith while their high-speed-stage carrier 12 is connected to and revolves about a shaft 3a of the low-speed-stage sun gear 3, and reference numeral 6 denotes a high-speed-stage sun gear that is rotationally driven by the high-speed-stage planet gears 5.

Note that the output shaft 10 is a rotary shaft of the high-speed-stage sun gear 6 and rotates together therewith.

In this sun-and-planet speed-up gear 25, the high-speed-stage ring gear 4 is fixed; and the rotation of the input shaft 9 is sequentially transferred to the low-speed-stage ring gear 1, the low-speed-stage planet gears 2, the low-speed-stage sun gear 3, the high-speed-stage planet gears 5, and the high-speed-stage sun gear 6 to increase in speed; and the rotation whose speed has been increased is output from the output shaft 10.

As shown in FIG. 3, in this embodiment, the shaft 3a of the low-speed-stage sun gear 3 and the high-speed-stage carrier 12 are coupled (connected) via a coupling 13 and a sleeve 14.

The coupling 13 is a cylindrical-shaped member having an I-shape in cross section that has a first flange 15 at one end (end located close to the high-speed-stage carrier 12) and that has a second flange 16 smaller in diameter than the first flange 15 at the other end (end located close to the low-speed-stage sun gear 3). In the first flange 15 and the high-speed-stage carrier 12, a plurality of (for example, four) through-holes 17 that pass therethrough in a plate-thickness direction are formed in the circumferential direction, and reamer bolts 18 pass through the through-holes 17. Then, the coupling 13 is secured (attached) to the high-speed-stage carrier 12 by means of the reamer bolts 18 that pass through the through-holes 17 and nuts 19 that screw together male screw parts 18a formed at the tips (ends located at the opposite side of the bolt heads) of the reamer bolts 18, such that an end face of the first flange 15 is brought into contact with a surface of the high-speed-stage carrier 12.

Note that, in this embodiment, the reamer bolts 18 and the nuts 19 are fastened such that the heads of the reamer bolts 18 protrude from the first flange 15, and the nuts 19 protrude from the high-speed-stage carrier 12.

Further, a flange 20 having the same diameter as the second flange 16 is formed at the tip (end facing the coupling 13) of the shaft 3a extending from the low-speed-stage sun gear 3.

The sleeve 14 is a hollow cylindrical-shaped member having the same inner diameter as the outer diameters of the second flange 16 and the flange 20 and is made from a rigid material or a flexible material. Further, the sleeve 14 is fitted radially outward, on the second flange 16 and the flange 20 such that the inner circumference face thereof is brought into contact with the outer circumference faces of the second flange 16 and the flange 20.

According to the sun-and-planet speed-up gear 25 of this embodiment, the flange 20, which is formed at the tip of the shaft 3a of the low-speed-stage sun gear 3, and the second flange 16, which is formed at the other end of the coupling 13 directly attached to the high-speed-stage carrier 12 via the reamer bolts 18 and the nuts 19, are coupled via the sleeve 14, so that the low-speed-stage sun gear 3 can move (somewhat: slightly) in parallel in the radial direction.

Therefore, when the low-speed-stage sun gear 3 is assembled, the low-speed-stage sun gear 3 is automatically centered (the low-speed-stage sun gear 3 automatically moves to a position where the distances between the center of the low-speed-stage sun gear 3 and the centers of the low-speed-stage planet gears 2 are equal), and thus damage to tooth surfaces of the low-speed-stage sun gear 3 and the low-speed-stage planet gears 2 and to a bearing (not shown) that rotatably supports the input shaft 9 can be prevented.

A sun-and-planet speed-up gear according to a second embodiment of the present invention will be described with reference to FIG. 4. FIG. 4 is a sectional view of the sun-and-planet speed-up gear according to this embodiment and is an enlarged main-portion view showing an enlarged main portion thereof.

As shown in FIG. 4, a sun-and-planet speed-up gear 30 of this embodiment differs from that described above in the first embodiment in that a coupling 31 is provided instead of the coupling 13. Since the other components are the same as those described above in the first embodiment, a description of the components will be omitted here.

The coupling 31 is a cylindrical-shaped member having a T-shape in cross section that has a flange 32 having the same diameter as the flange 20 at one end (end located close to the low-speed-stage sun gear 3) and is shorter in length in the axial direction (longitudinal direction) than the coupling 13, described in the first embodiment (approximately one third of the coupling 13). Also, in the flange 32 and the high-speed-stage carrier 12, a plurality of (for example, four) through-holes 33 that pass therethrough in the plate-thickness direction are formed in the circumferential direction, and the reamer bolts 18 pass through the through-holes 33. Then, the coupling 31 is secured (attached) to the high-speed-stage carrier 12 by means of the reamer bolts 18 that pass through the through-holes 33 and the nuts 19, which screw together the male screw parts 18a formed at the tips (ends located at the opposite side of the bolt heads) of the reamer bolts 18, such that the other end face of the coupling 31 (end face facing a surface of the high-speed-stage carrier 12) is brought into contact with the surface of the high-speed-stage carrier 12.

On the other hand, a protrusion part 34 that protrudes toward an end face of the shaft 3a and that has a length (height) in the axial direction (longitudinal direction) longer (higher) than the height (thickness) of the bolt heads of the reamer bolts 18 is formed at the center of one end face of the coupling 31.

This can prevent damage to the bolt heads caused when the end faces (top faces) of the bolt heads are brought into contact with the end face of the shaft 3a.

Note that, in this embodiment, the reamer bolts 18 and the nuts 19 are fastened such that the heads of the reamer bolts 18 protrude from the first flange 32, and the nuts 19 protrude from the high-speed-stage carrier 12.

Further, the sleeve 14 is fitted radially outward, on the flange 20 and the flange 32 such that the inner circumference face thereof is brought into contact with the outer circumference faces of the flange 20 and the flange 32.

According to the sun-and-planet speed-up gear 30 of this embodiment, the flange 20, which is formed at the tip of the shaft 3a of the low-speed-stage sun gear 3, and the flange 32, formed at one end of the coupling 31 directly attached to the high-speed-stage carrier 12 via the reamer bolts 18 and the nuts 19, are coupled via the sleeve 14, so that the low-speed-stage sun gear 3 can move (somewhat: slightly) in parallel in the radial direction.

Therefore, when the low-speed-stage sun gear 3 is assembled, the low-speed-stage sun gear 3 is automatically centered (the low-speed-stage sun gear 3 automatically moves to a position where the distances between the center of the low-speed-stage sun gear 3 and the centers of the low-speed-stage planet gears 2 are equal), and thus damage to tooth surfaces of the low-speed-stage sun gear 3 and the low-speed-stage planet gears 2 and to a bearing (not shown) that rotatably supports the input shaft 9 can be prevented.

Furthermore, according to the sun-and-planet speed-up gear 30 of this embodiment, the coupling 31, which is shorter in length in the axial direction than that of the first embodiment, is used, thereby allowing a reduction in size in the axial direction, making the gear more compact.

A sun-and-planet speed-up gear according to a third embodiment of the present invention will be described with reference to FIG. 5. FIG. 5 is a sectional view of the sun-and-planet speed-up gear according to this embodiment and is an enlarged main-portion view showing an enlarged main portion thereof.

As shown in FIG. 5, a sun-and-planet speed-up gear 40 of this embodiment differs from that described above in the first embodiment in that a coupling 41 is provided instead of the coupling 13 and the sleeve 14. Since the other components are the same as those described above in the first embodiment, a description of the components will be omitted here.

The coupling 41 is a circular-disc-shaped member having approximately the same diameter as a flange 42 that is formed at the tip (end facing the coupling 41) of the shaft 3a, extending from the low-speed-stage sun gear 3, is formed from a flexible material, and is shorter in length in the axial direction (longitudinal direction) than the coupling 13, described in the first embodiment (approximately one third of the coupling 13). Also, in the coupling 41 and the high-speed-stage carrier 12, a plurality of (for example, two) through-holes 43 that pass therethrough in the plate-thickness direction are formed in the circumferential direction, and the reamer bolts 18 pass through the through-holes 43. Then, the coupling 41 is secured (attached) to the high-speed-stage carrier 12 by means of the reamer bolts 18 that pass through the through-holes 43 and the nuts 19, which screw together the male screw parts 18a formed at the tips (ends located at the opposite side of the bolt heads) of the reamer bolts 18, such that part of one end face of the coupling 41 (end face facing the surface of the high-speed-stage carrier 12) is brought into contact with the surface of the high-speed-stage carrier 12. Further, in the coupling 41 and the flange 42, a plurality of (for example, two) through-holes 44 that pass therethrough in the plate-thickness direction are formed in the circumferential direction, and the reamer bolts 18 pass through the through-holes 44. Then, the coupling 41 is secured (attached) to the flange 42 by means of the reamer bolts 18 that pass through the through-holes 44 and the nuts 19, which screw together the male screw parts 18a formed at the tips (ends located at the opposite side of the bolt heads) of the reamer bolts 18, such that part of the other end face of the coupling 41 (end face facing an end face of the flange 42) is brought into contact with the end face of the flange 42.

Note that, in this embodiment, the reamer bolts 18 and the nuts 19 that couple the coupling 41 and the high-speed-stage carrier 12 are fastened such that the heads of the reamer bolts 18 protrude from the coupling 41, and the nuts 19 protrude from the high-speed-stage carrier 12. On the other hand, the reamer bolts 18 and the nuts 19 that couple the coupling 41 and the flange 42 are fastened such that the heads of the reamer bolts 18 protrude from the coupling 41, and the nuts 19 protrude from the flange 42.

According to the sun-and-planet speed-up gear 40 of this embodiment, the low-speed-stage sun gear 3 and the high-speed-stage carrier 12 are coupled via the flexible coupling 41 one end of which is directly attached to the flange 42, formed at the tip of the shaft 3a of the low-speed-stage sun gear 3, via the reamer bolts 18 and the nuts 19, and the other end of which is directly attached to the high-speed-stage carrier 12 via the reamer bolts 18 and the nuts 19, so that the low-speed-stage sun gear 3 can move (somewhat: slightly) in parallel in the radial direction.

Therefore, when the low-speed-stage sun gear 3 is assembled, the low-speed-stage sun gear 3 is automatically centered (the low-speed-stage sun gear 3 automatically moves to a position where the distances between the center of the low-speed-stage sun gear 3 and the centers of the low-speed-stage planet gears 2 are equal), and thus damage to tooth surfaces of the low-speed-stage sun gear 3 and the low-speed-stage planet gears 2 and to a bearing (not shown) that rotatably supports the input shaft 9 can be prevented.

Furthermore, according to the sun-and-planet speed-up gear 40 of this embodiment, the coupling 41, which is shorter in length in the axial direction than that of the first embodiment, is used, thereby allowing a reduction in size in the axial direction, making the gear more compact.

Note that the present invention is not limited to the above-described embodiments; and various changes and modifications are allowed without departing from the gist of the present invention.

For example, in the above-described embodiments, the reamer bolts 18 and the nuts 19 are used as specific examples of fastening means; however, instead of the reamer bolts 18 and the nuts 19, pins can be used to couple a coupling to the high-speed-stage carrier 12 or the low-speed-stage sun gear 3.

In that case, it is just necessary to put the tips of the pins into the high-speed-stage carrier 12 or the low-speed-stage sun gear 3, thereby improving the assembly properties (manufacturing properties).

Further, in the above-described embodiments, descriptions have been given of the specific example cases in which the coupling 13 or 31 is coupled to the high-speed-stage carrier 12 via the reamer bolts 18 and the nuts 19; however, the coupling 13 or 31 and the high-speed-stage carrier 12 may be formed as a unit.

### REFERENCE SIGNS LIST

1 low-speed-stage ring gear
2 low-speed-stage planet gears
3 low-speed-stage sun gear
3a shaft
6 high-speed-stage sun gear
9 input shaft
10 output shaft
12 high-speed-stage carrier
13 coupling
14 sleeve
16 second flange (flange)
20 flange
25 sun-and-planet speed-up gear
30 sun-and-planet speed-up gear
31 coupling
32 flange
40 sun-and-planet speed-up gear
41 coupling
42 flange

1. A sun-and-planet speed-up gear comprising:
a low-speed-stage sun-and-planet gearing; and
a high-speed-stage sun-and-planet gearing,
an input shaft being connected to a low-speed-stage ring gear,
the position of a shaft of a low-speed-stage planet gear being secured,
a shaft of a low-speed-stage sun gear being connected to a high-speed-stage carrier, and
an output shaft being connected to the high-speed-stage sun gear,
wherein a flange formed at a tip of the shaft of the low-speed-stage sun gear and a flange formed at a tip of a coupling that is directly attached to the high-speed-stage carrier or that is formed on the high-speed-stage carrier are coupled via a sleeve.

2. A sun-and-planet speed-up gear comprising:
a low-speed-stage sun-and-planet gearing; and
a high-speed-stage sun-and-planet gearing,
an input shaft being connected to a low-speed-stage ring gear,
the position of a shaft of a low-speed-stage planet gear being secured,
a shaft of a low-speed-stage sun gear being connected to a high-speed-stage carrier, and
an output shaft being connected to the high-speed-stage sun gear,
wherein coupling is made via a flexible coupling one end of which is attached to a flange formed at a tip of the shaft of the low-speed-stage sun gear and the other end of which is attached to the high-speed-stage carrier.

3. A wind turbine comprising a sun-and-planet speed-up gear according to claim 1.
